(19) United States
(12) Patent Application Publication
(10) Pub. No.: US 2007/0224575 A1
(43) Pub. Date: Sep. 27, 2007

(54) Ultrasonic Dental Tool

(76) Inventors: Francis Dieras, Bordeaux (FR); Yann Lepetitcorps, Leognan (FR)

Correspondence Address: YOUNG & THOMPSON, 745 SOUTH 23RD STREET, 2ND FLOOR, ARLINGTON, VA, 22202, US

(21) Appl. No.: 11/587,435

(22) PCT Filed: May 4, 2005
(86) PCT No.: PCT/FR05/01122

§ 371 Date: Jan. 24, 2007

(30) Foreign Application Priority Data
May 5, 2004 (FR) 0404835

(51) Int. Cl. A61C 17/20

(52) U.S. Cl. 433/119

(57) ABSTRACT

The invention relates to a dental tool or insert driven by ultrasonic vibration and made of a titanium and aluminium-based alloy. The inventive dental tool comprises, in the form of the component thereof, at least one biocompatible betagene element which is made of niobium and/or molybdenum and/or tantalum and generates at least 40% of crystalline phase of a centred cubic structure.

The present invention relates to an ultrasonic dental instrument and more particularly to an instrument intended for uses in the domain of periodontology and endodontics.

It is known that scaling, which is an act commonly carried out in the field of dentistry within the framework of prophylactic treatments, consists in removing the tartar present on the tooth surfaces by means of a manual or mechanized instrument, particularly an instrument set in motion by ultra-sounds.

It is also known that the purpose of periodontal treatment is to eliminate the bacterial plaque located beneath the gum and which, constituted by tartar and toxins, constitutes one of the etiological factors of inflammatory lesions of the periodontium that may, in the long run, lead to the teeth dropping out.

In the past, one usually proceeded with a root surfacing consisting in eliminating the cement covering the root of the tooth in its subgingival part and the intoxicated dentine of which the bacteria produce endotoxins such as the liposaccharides issuing from the wall of the GRAM negative bacteria. In effect, these liposaccharides exert an inhibiting action on the gingival fibroplasts indispensable for holding the periodontium. However, recent studies have shown that these endotoxins adhered weakly to the root surface, did not penetrate the cement and therefore that it was not necessary to exert an excessive pressure on the walls to be treated. Furthermore, these results confirmed that it was unnecessary to proceed with an exeresis of the cement.

This is why practitioners have since then abandoned root surfacing, considered as being too aggressive, in favour of debridement of the periodontium. This intervention makes it possible to obtain an efficient decontamination of the root surface and guarantees an acceptable elimination of the toxic agents. In order to be efficient, subgingival debridement is most often accompanied by the treatment of the furcations, namely that of the internal walls of the roots of the multi-rooted teeth such as the molars or the premolars.

In order to carry out such treatment, manual instruments of the Gracey curette type have gradually been replaced by mechanized instruments set in motion by high intensity ultra-sounds at frequencies included between 25 000 and 35 000 Hz. Such apparatus, abundantly described in the prior state of the art, are essentially constituted by a ultrasound generator furnishing the energy to a magnetostrictive or piezo-electric transducer which ensures the displacement of a removable metallic tool called an insert.

By actuating these inserts by ultra-sounds, the practitioners are able to adopt operative gestures which are both extremely precise and adapted to develop an energy allowing them to carry out the treatments more rapidly and with greater efficiency. Furthermore, it has been observed that the displacement of the inserts in a liquid medium constituted by the irrigation liquid has the effect of generating a cavitation effect making it possible to effect a cleaning which efficiently eliminates the pathogenic subgingival compressions.

It will thus be understood that the inserts are therefore tools which must satisfy several specific types of requirements. In effect, they must firstly be able to take the most diverse forms in order to allow the practitioner to work in zones which are often difficult to access. Secondly they must present parts of small dimensions which are appropriate for the zones of the patient's teeth to be treated. Moreover, they must make it possible to precisely control the transmission of the ultrasound energy that they receive via their posterior end in order to transmit it to their active end. Finally, they must be biocompatible.

It will be understood, under these conditions, that the alloys that may be used to constitute such inserts must also present clearly specified mechanical characteristics.

Inserts of this type, based on titanium and aluminium presenting both the suppleness required for use in the dental field and particularly in that of the field of periodontology and which are adapted to re-transmit the energy received in particularly efficient manner, are already known in the prior state of the art.

The present invention has for its object to propose a dental instrument comprising both a suppleness appropriate for operations in periodontology, endodontics or prophylaxis, and an optimum transmission of the ultrasound energy.

The present invention thus relates to a dental instrument, or insert, of the type set in motion by ultrasound vibrations and constituted by a titanium- and aluminium-based alloy, characterized in that it comprises, as component, at least one biocompatible betagenic element constituted by niobium and/or molybdenum and/or tantalum adapted to generate at least 40% of crystalline phase of centred cubic structure.

When this betagenic element is constituted by niobium, its percentage in value by mass in the alloy will preferably be 7%. The present invention thus makes it possible to produce in particular an alloy whose formula is Ti₆Al₇Nb.

According to the invention, the crystalline structure of the alloy will preferably be such that the grains thereof will have a dimension smaller than 10 micrometers.

A form of embodiment of the present invention will be described hereinafter by way of non-limiting example, with reference to the accompanying drawings, in which:

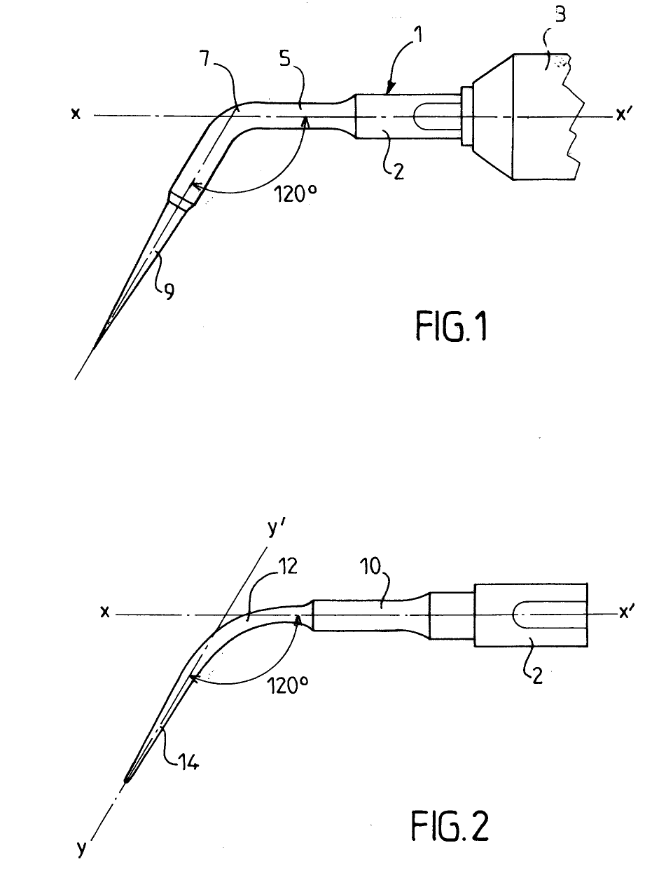

FIG. 1 is a view of a dental instrument, or insert, according to the invention, disposed on an ultrasound handpiece.

FIG. 2 is a plan view with partial section of a periodontological insert according to the invention intended to carry out a subgingival treatment.

The various studies and tests made within the framework of the concept of the present invention have made it possible to establish that there is a correlation between the ability for an insert to transmit the ultrasound energy and the atomic structure of the alloy used for making this insert. More precisely, it has been established that the existence of a crystalline structure combined with a preponderance of it in phase β (or, for a titanium alloy, the preponderance in crystalline phase of centred cubic structure) would give this alloy an isotropy such that it ensured an efficient transmission of the ultrasound energy. Furthermore, it has been observed that the isotropic nature of the alloy had the effect of giving it a low granulometry, contributing to improving the transmission obtained.

The tests which were carried out within the framework of the present invention have established that elements (hereinafter called “betagenic” elements) such as niobium, molybdenum and tantalum when they were associated with a base constituted by titanium comprising a low percentage of aluminium (of the order of 6% by mass) had the property of giving the alloy a crystalline structure comprising a majority of centred cubic structure giving to this alloy a particularly efficient transmission of ultrasounds.

Inserts have for example been made in a Ti₆Al₇Nb alloy, i.e. an alloy based on titanium comprising in percentage by mass 6% of aluminium and 7% of niobium. During work in situ, it has been observed that such inserts, compared to inserts of the same shape and dimension, presented the advantage of transmitting greater powers while conserving appropriate qualities of suppleness.

According to the invention, inserts may also be made in alloys employing several betagenic elements such as for example tantalum, molybdenum and niobium. Inserts have for example be made in an alloy comprising these three betagenic elements, in accordance with the formula: Ti₆Al₂Nb₁Ta_{0.8}Mo, i.e. the alloy based on titanium and 6% aluminium comprises, in proportions by mass, 2% of niobium, 1% of tantalum and 0.8% of molybdenum. The tests carried out showed that the transmission of the ultrasound energy was located above that obtained with inserts of conventional stainless steel type but below that obtained with a betagenic element constituted exclusively of niobium such as the alloy mentioned previously: Ti₆Al₇Nb.

It has also been established that this alloy was particularly appropriate for manufacturing inserts intended in particular for carrying out interventions in operative dentistry, taking the form shown by way of example in FIG. 1.

In FIG. 1, the proximal end of this insert 1 is formed by a cylindrical part 2 by which it is intended to be connected on an ultrasound handpiece 3 which continues towards its distal end in a cylindrical part 5 of smaller diameter forming a bend 7 making an angle of about 120° with the longitudinal axis xx′ of the insert, followed by a conical zone 9 whose base presents a diameter smaller than that of the cylindrical part.

FIG. 2 shows a periodontological insert used for effecting subgingival treatments. This insert, which is intended to be connected on an ultrasound handpiece (not shown in the drawing), has a cylindrical proximal end 2 which continues towards its other end in a second cylindrical part 10 of smaller diameter which extends in a part whose diameter decreases continuously up to its tip, or distal end, which is formed by two zones, namely a first zone 12 curved along a radius and a second zone 14 extending the first which is of conical shape and whose longitudinal axis yy′ forms an angle of about 120° with the principal longitudinal axis xx′ of the insert.

1-6. (canceled)

7. Dental instrument, or insert, of the type set in motion by ultrasound vibrations and constituted by a titanium- and aluminium-based alloy, characterized in that it comprises, as component, at least one biocompatible betagenic element constituted by niobium and/or molybdenum and/or tantalum adapted to generate at least 40% of crystalline phase of centred cubic structure.

8. Dental instrument according to claim 7, characterized in that the betagenic element is constituted by niobium, its percentage in value by mass in the alloy being about 7%.

9. Dental instrument according to claim 8, characterized in that it is made of an alloy having the formula Ti₆Al₇Nb.

10. Dental instrument according to claim 7, characterized in that the crystalline structure of the alloy is such that the grains thereof have a dimension less than 10 μm.

11. Dental instrument according to claim 7, characterized in that its shape is such that its proximal end is formed by a cylindrical part (2) by which it is intended to be connected on an ultrasound handpiece (3) which continues towards its distal end in a cylindrical part (5) of smaller diameter forming a bend (7) making an angle of about 120° with the longitudinal axis (xx′) of the insert followed by a conical zone (9) whose base presents a diameter smaller than that of the cylindrical part.

12. Dental instrument according to one of claims 7, characterized in that its shape is such that its proximal end (2) is cylindrical and continues towards its other end in a second cylindrical part (10) of smaller diameter which extends in a part whose diameter decreases continuously up to its tip, or distal end, which is divided into two zones, namely a first zone (12) curved along a radius and a second zone (14) extending the first which is of conical shape and whose longitudinal axis (yy′) forms an angle of about 120° with the principal longitudinal axis (xx′) of the insert.
